(19) United States
(12) Patent Application Publication
(10) Pub. No.: US 2014/0067971 A1
(43) Pub. Date: Mar. 6, 2014

(54) Method and Arrangement for Controlling Actions in a Notification Service

(71) Applicants: Christer Boberg, Tungelsta (SE); Per Orvebratt, Älta (SE); Mikael Klein, Huddinge (SE); Anders Lindgren, Älvsjö (SE)

(72) Inventors: Christer Boberg, Tungelsta (SE); Per Orvebratt, Älta (SE); Mikael Klein, Huddinge (SE); Anders Lindgren, Älvsjö (SE)

(73) Assignee: TELEFONAKTIEBOLAGET L M ERICSSON (PUBL), Stockholm (SE)

(21) Appl. No.: 14/005,780

(22) PCT Filed: Mar. 23, 2011
(86) PCT No.: PCT/SE11/50320

§ 371 Date: Sep. 17, 2013

(51) Int. Cl. H04L 12/58

(52) U.S. Cl. CPC H04L 51/24
USPC 709/206

(57) ABSTRACT

Method and arrangement for controlling actions in a notification server (200) that (for A or B) provides notifications regarding a presentity (B) to a subscribing watcher (A). When a request is received(2:1) from a requesting party (A, B or 208) for an additional action apart from the regular notifications, an action rule is activated (2:3) in an action rules repository (202). The action rule comprises a trigger condition for performing the requested additional action. When an event publication is received(2:4) referring to the presentity, the event publication is checked(2:6) against the action rule to determine whether the trigger condition is fulfilled or not by the event publication. If so, the additional action is executed (2:7). Thereby, the additional action can be put into practice and controlled automatically within the framework of the ongoing notification service.

### TECHNICAL FIELD

The invention relates generally to a method and an arrangement for controlling actions related to watchers or presentities involved in notification services.

### BACKGROUND

Messaging services are becoming increasingly popular amongst terminal users in communication networks. A particular example is the presence services which basically make data related to a specific client available to other clients over a communication network. In presence services, presence data of a client is collected and stored in a presence server and can then be delivered to clients subscribing to that presence data. In this context, a “client” is typically a terminal user in the communication network, although in some practical cases it can also be a “machine function” such as an application, sensor or counter.

The presence data may refer to various parameters and characteristics of the clients, including information relating to, e.g., terminal status, capabilities, selections and settings, as well as information relating to the current situation of the client such as availability, geographic location and physical environment. The presence data may also include more personal information, e.g. interests and needs, current activities, personal characteristics, moods, and so forth. A client may subscribe to selected presence data or “updatings” of other clients in order to receive notifications with such information.

This type of information is typically collected on a continuous basis in presence servers based on publications received from any “presence sources” associated with the clients, such as user terminals, M2M (Machine-to-Machine) devices and access networks, whenever any presence data for a client is introduced, updated, changed or deleted. In this field, the term “watcher” represents a client that subscribes to and receives presence data, while a “presentity” represents a client that publishes presence data in the presence server to be available for any authorized watchers. Accordingly, the presence server sends published presence data in notifications to the watchers, typically in the form of XML (Extensible Mark-up Language) documents.

The protocol SIP (Session Initiation Protocol) is typically used as a framework for the above handling of presence data over the communication network. The SIP message called “SIP PUBLISH” is used by presentities to send presence data to the presence server for publication. Another SIP message called “SIP SUBSCRIBE” is used by watchers to request for presence data of presentities. Yet another SIP message called “SIP NOTIFY” is used by the presence server to deliver fresh presence data to watchers. Alternatively, HTTP (Hypertext Transfer Protocol) can be used in presence services, e.g. the presentity may use a regular “HTTP PUT” message or HTTP POST message to publish data.

FIG. 1 illustrates a conventional procedure for providing presence data, involving a watcher A, a presentity B and a presence server 100 which stores presence data of the presentity B in a data storage 102. A first action 1:1a generally illustrates that presence data is published for the presentity B by frequent publication messages to the presence server 100 according to conventional routines, either sent from B or from B's access network (not shown). Such publications or updatings of presence data is often referred to as “events” which term will be used in this description. A next action 1:1b illustrates that data storage 102 is updated according to the publications of action 1:1a. Actions 1:1a and 1:1b may continue throughout in the background, according to prevailing routines.

In an action 1:2, watcher A sends a subscription request for presence data of presentity B, in which a time-out parameter for a desired subscription time period may be specified. Alternatively, the subscription request may be a one-time request whenever the watcher wants the information. The presence server 100 then retrieves presence data of presentity B from data storage 102 in an action 1:3, and sends it to watcher A in an initial notification message, as shown in another action 1:4. As indicated by the dashed arrows in step 1:4, watcher A may receive such notifications on further occasions e.g. according to a preset subscription time, at regular intervals or whenever the presence data is changed, or just once per request, depending on the subscription model.

It is sometimes desirable to perform an additional action that is induced or caused by a publication of presentity data with the presence server, apart from just sending a notification to the subscribing watcher. For example, some logic of processing or handling the published data may be relevant to perform in some situations or conditions. It may also be desirable to send a specific message to the watcher or the presentity, or even to a third party, whenever a certain condition prevails. Today, no solution for how this can be accomplished is available which is identified as a problem.

### SUMMARY

It is an object of the invention to address at least some of the problems and shortcomings outlined above. It is possible to achieve these objects and others by using a method and an arrangement as defined in the attached independent claims.

According to one aspect, a method is provided for controlling actions in a notification server that provides notifications regarding a presentity to a subscribing watcher. In this method, a request is received from a requesting party for an additional action apart from the sending of said notifications and dependent on event publications referring to the presentity. The notification server then activates an action rule in an action rules repository, the action rule comprising a trigger condition for performing the requested additional action. When an event publication referring to the presentity is received, the notification server checks the event publication against said action rule to determine whether the trigger condition in the action rule is fulfilled or not by the event publication. If it is found that the trigger condition is fulfilled, the notification server executes or initiates the additional action accordingly.

According to another aspect, an arrangement is provided in a notification server configured to provide notifications regarding a presentity to a subscribing watcher. The notification server arrangement comprises a first receiving module adapted to receive from a requesting party a request for an additional action apart from said notifications and dependent on event publications referring to the presentity. The arrangement further comprises a rule handling module adapted to activate an action rule in an action rules repository, the action rule comprising a trigger condition for performing the requested additional action. The arrangement further comprises a second receiving module adapted to receive an event publication referring to the presentity, and a rule checking module adapted to check the event publication against said action rule to determine whether said trigger condition in the action rule is fulfilled or not by the event publication. An action module in the notification server is adapted to execute or initiate said additional action if the trigger condition in the action rule is fulfilled.

By using the above solution, any wanted additional action, apart from regular notifications according to an ongoing notification service, can be initiated automatically by means of the existing and currently used framework for the notification service, such that the additional action is triggered by event publications of the presentity. An action rule with one or more trigger conditions can be freely selected or created to provide a customized or personalized control of how and when the additional action is to be executed. The requesting party may be one of: the watcher, the presentity, a third party and an administrator associated with the watcher or the presentity.

The above method and arrangement may be configured and implemented according to different optional embodiments. In some possible embodiments, the trigger condition refers to at least one of: type of event publication, time of day, week or season, and a value of a reported parameter in the event publication. In other embodiments, the additional action or the trigger condition may refer to a specific presentity or watcher or generally to any presentity or watcher.

In order to activate the action rule, a new action rule may be created or defined and installed in the action rules repository, or alternatively an already existing action may be selected for activation in the action rules repository. Further, the notification server may receive the request for an additional action in an XCAP message or in a SUBSCRIBE message.

In further embodiments, it is also possible for the notification server to perform at least one of: authorising the requesting party based on preset access rules, and authenticating the requesting party based on preset authentication rules, before activating said action rule.

The additional action may involve at least one of: a logic for processing or handling information in the event publication, and sending an e-mail to the watcher or the presentity or to a third party. The action rule may determine at least one of the following: whether a notification is to be sent to the watcher or not, and whether a report, result or outcome of the additional action is to be included in the notification. The notification server may further receive the event publication as a notification from another notification server in the case when the presentity and watcher are served by different notification servers.

Further possible features and benefits of this solution will become apparent from the detailed description below.

### BRIEF DESCRIPTION OF DRAWINGS

The invention will now be described in more detail by means of exemplary embodiments and with reference to the accompanying drawings, in which:

FIG. 1 is a communication scenario illustrating a regular presence service with notifications, according to the prior art.

FIG. 2 is a block diagram illustrating how additional actions can be controlled in a notification server, according to some possible embodiments.

FIG. 3 is a flow chart illustrating a configuration procedure for controlling additional actions in a notification server, according to further possible embodiments.

FIG. 4 is a flow chart illustrating a run-time procedure for controlling additional actions in a notification server, according to further possible embodiments.

FIG. 5 is a block diagram illustrating a notification server in more detail, according to further possible embodiments.

FIG. 6 is a block diagram illustrating how additional actions can be controlled when the presentity and watcher are served by different notification servers, according to further possible embodiments.

### DETAILED DESCRIPTION

Briefly described, a solution is provided in a notification server that regularly sends notifications regarding a presentity to a subscribing watcher according to an ongoing notification service, e.g. a presence service. This solution enables the notification server to control the execution of an additional action triggered by a received event publication referring to the presentity according to an action rule, apart from just sending a notification to the watcher. The action rule comprises a definition or description of the additional action and a trigger condition which controls when the action is to be executed. In this solution, control of the additional action can be implemented by means of a messaging framework currently used in the notification service, e.g. a presence framework and/or using XCAP messages and XML documents which are used in SIMPLE Presence among other things, although the solution is not limited to any particular messaging framework for notification services.

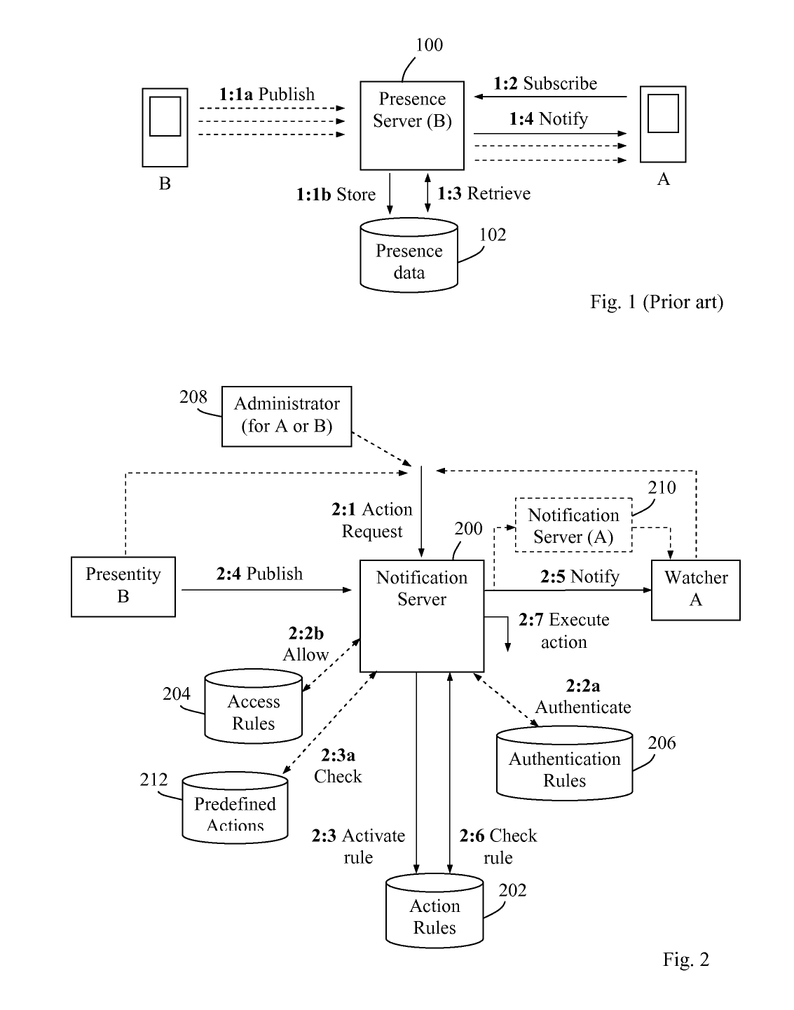

By way of example but without limitation, the notification server may be a presence server or the like that sends notifications to a watcher containing published information or updates of a presentity according to a more or less ordinary presence service or similar notification service, e.g. in the manner described above for FIG. 1. The term “event publication” is used to represent any published data sent to the presence server 100 referring to the presentity, e.g. presence data and similar updatings by means of any of the above-mentioned messages for publishing data as of action 1:1a, either sent from the presentity itself or from the presentity's access network, not shown, according to conventional routines.

The above-mentioned “additional action” in this solution may be any action dependent on or triggered by event publications referring to the presentity, apart from the action of sending a notification to the watcher according to the ongoing notification service. The additional action may in this context involve, e.g., a logic for processing or handling the information in the event publication, or the sending of an e-mail with a certain message to the watcher or the presentity or to a third party. This solution is not limited to any particular additional actions. The additional action will be executed, or at least initiated by the notification server, if a trigger condition in a predefined action rule is fulfilled, according to the mechanism described below. For example, the additional action may be that an e-mail containing the published data of the presentity is to be sent to a third party in addition to a regular notification to the watcher, provided that the trigger condition is fulfilled.

With reference to a communication scenario illustrated in FIG. 2, an example of how such an additional action can be controlled in a notification server 200 in accordance with this solution, will now be described. It is assumed that the notification server 200 also provides notifications regarding a presentity B to a subscribing watcher A essentially according to any notification service, conventional or not, such as a presence service. The sending of notifications to watcher A is however not limited to any particular scheme in this solution. For example, a notification may be suppressed for whatever reason, or a notification may further contain an outcome or result of the additional action, and so forth. Further, the watcher A may be served by the same notification server 200 as the presentity, or by another notification server 210, as indicated by dashed lines in the figure, e.g. a so-called RLS (Resource List Server) which is a server that allows subscriptions to a list of users such as presentity B. In the solution described here, the existing mechanism and framework of the notification service are utilised in a useful manner for enabling and triggering a wanted additional action besides the actual notification service, as follows.

A first act 2:1 illustrates that the notification server 200 receives a request for an additional action, apart from the regular notifications, which is dependent on or triggered by event publications referring to the presentity. The action request is generally received from a “requesting party” which could be the watcher A, the presentity B or an administrator 208 associated with A or B or with a third party, not shown. In the case where watcher A is served by a separate notification server 210, the request may come via that server 210 from watcher A, not shown. The requesting party may send the action request in a SUBSCRIBE message or in an XCAP PUT message, or in any other type of message within the currently used notification service framework, and may further refer to an existing additional action which has already been defined in a storage 212. Alternatively, the requesting party may in some cases define or describe the requested additional action in an XML document in the action request, XML documents being typically used within the normal presence framework anyway.

In this solution, the requested additional action is realized by activating an action rule to be applied whenever an event publication referring to the presentity B is received at the notification server 200. However, before activating the action rule in this example, the requesting party may be authenticated based on preset authentication rules retained in a database 206, as shown in an act 2:2a, to determine basically if the requesting party is valid and reliable. Furthermore, the requesting party may also be authorised based on preset access rules retained in another database 204, as shown in an act 2:2b, to determine if the requesting party can be allowed to put the requested action into practice. Acts 2:2a and 2:2b may be done in any order. This authorization and authentication of the requesting party may be performed basically in the same way as when a watcher submits a subscription request for data of a presentity.

Assuming that the outcome of acts 2:2a and 2:2b, if executed, is positive such that the requesting party is trustworthy and allowed, a next act 2:3 illustrates that the notification server 200 activates an action rule for the requested additional action in an action rules repository 202. It is further assumed that the notification server 200 has a logic for creating or selecting a suitable action rule based on the action request received in act 2:1. Activating the action rule may comprise either creating and installing a new action rule in the action rules repository, or selecting and activating an already existing action rule in the action rules repository, to be described in more detail below.

The activated action rule is also associated to the presentity B in the action rules repository such that an event publication referring to that presentity can trigger the action to be executed according to the action rule. The activated action rule may also be associated to the watcher A if the additional action in some way involves A. In the case when presentity B and watcher A are served by different notification servers 200 and 210, respectively, the action rule may be handled by the other notification server 210, and the event publication that triggers the additional action may be received at server 210 in the form of a notification from notification server 200, which will be described in more detail later on with reference to another example.

In particular, the action rule comprises a trigger condition for performing the additional action, which is to be evaluated whenever an event publication referring to the presentity B is received at server 200. The additional action or the trigger condition trigger condition may be either “specific” by referring to a specific presentity or watcher, or “generic” by referring generally to any presentity or watcher.

For example, the trigger condition may refer to one or more of: the type of event publication, the time of day, week or season, a value of a reported parameter in the event publication, and so forth. In the latter case, the trigger condition may be that the additional action should be executed if a reported parameter value exceeds, alternatively does not exceed, a preset level. An example of this could be that when an M2M device sends an event publication with a temperature value that exceeds a threshold set in the trigger condition, the action rule dictates that an alarm message is to be sent to an emergency centre as the additional action.

In another example, the trigger condition may refer to the time of the event publication or to a current location, and the action rule may dictate that the additional action should only be executed on Sundays between 10 a.m. and 5 p.m., or when the watcher or presentity is located in a certain area, respectively. Further, the requesting party may request for an additional action based on a plurality of action rules and/or trigger conditions, which is also possible to put into practice by means of this solution.

When activating the action rule in act 2:3, it may be checked, as shown in an optional act 2:3a, whether any action that would be appropriate for the action request has already been defined in a storage 212 with predefined actions. In that case, the already existing action is selected from storage 212 to fit the request and the selected action is installed and activated as an action rule in the repository 202. Otherwise, a new action rule may accordingly be created to fit the request and installed in the action rules repository 202. In that case, the notification server 200 may manage and upload the new action rule to the repository 202 by using XCAP.

The above acts 2:1-2:3 (2:3a) basically refer to a configuration procedure for setting up the mechanism for controlling actions in the notification server. The following acts refer rather to a run-time procedure when the controlling of additional actions is put into practice, starting with an act 2:4 when the notification server 200 receives an event publication referring to the presentity B. Another act 2:5 illustrates that the notification server 200 may send a regular notification to the watcher A according to the ongoing notification service, although the notification may alternatively be suppressed depending on the notification service, which is however somewhat insignificant as such to the present solution.

A next act 2:6 illustrates that the notification server 200 checks the received event publication against the action rule in repository 202 to determine whether the trigger condition in the action rule is fulfilled or not by the event publication. Depending on the outcome of the check above, the additional action is executed if the trigger condition in the action rule is deemed to be fulfilled, as shown by a schematic act 2:7. How the actual action is initiated and performed is somewhat outside the scope of this solution. For example, the notification server 200 may execute the action by itself, or may trigger another node or function to execute the action, e.g. a separate notification server 210 serving watcher A. Furthermore, the shown act 2:5 of sending a notification to the watcher may be performed after execution of the additional action in act 2:7, and this notification may even contain some report, result or outcome of the executed action.

In this way, any wanted additional action triggered by event publications of the presentity can be initiated automatically by means of the existing and currently used framework for a notification service. As mentioned above, the action rule and its one or more trigger conditions can be freely selected or created to provide a customized or personalized control of how and when the additional action is to be executed. In other words, the action rule comprises basically a definition or description of how the additional action is to be performed and a trigger condition for determining when the additional action is to be performed. Further, both the watcher and the presentity may obtain control of whether the requesting party can be allowed to implement the action rule by influencing the access rules 204 and/or the authentication rules 206.

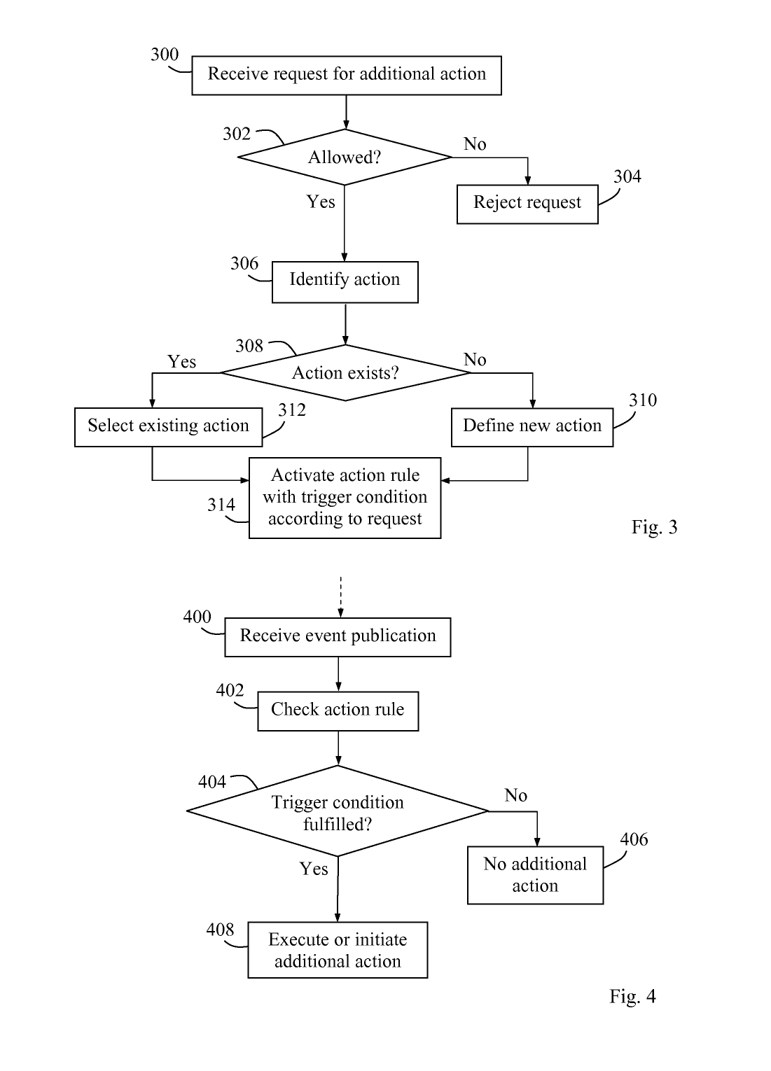

A procedure for controlling actions in a notification server that provides notifications regarding a presentity to a subscribing watcher, will now be described with reference to FIG. 3. This procedure basically corresponds to the above-mentioned configuration procedure and includes various steps or acts that may be executed in a notification server such as the notification server 200 in FIG. 2. This example again refers to a “requesting party” which could be any of the presentity, watcher and administrator in the above example.

In a first shown act 300, the notification server receives a request from the requesting party for an additional action apart from said notifications and which is dependent on or triggered by event publications referring to the presentity, basically corresponding to act 2:1 above. In this example, it is then determined in an act 302 whether the requesting party can be allowed to put the additional action into practice, e.g. depending on preset access rules and/or authentication rules, basically corresponding to acts 2:2a and 2:2b above. If not allowed, a suitable reject message may be sent to the requesting party in an act 304.

If the requesting party was allowed in act 302, the notification server identifies the requested additional action, in a further act 306. It is then determined in an act 308 whether the action already exists in a storage with predefined actions, such as the storage 212 in FIG. 2. If not, the notification server defines a new action based on the requested additional action, in a further act 310. The new action may be further based on the present access rules. On the other hand, if it is found in act 308 that a fitting predefined action already exists, the predefined action is selected in an act 312, to satisfy the received action request.

Finally, an action rule is defined and activated in the action rules repository with the created or selected action and at least one trigger condition according to the request, in an act 314, basically corresponding to act 2:3 above, thus completing the configuration phase of this solution. Activating the action rule means basically that it is applied or “enforced” for incoming event publications. It should be noted that the activated action rule is also associated to the presentity in the action rules repository in a suitable manner in action 314.

The action rule may be defined in the action rules repository as an XML document or similar and comprises basically a definition or description of the additional action and the trigger condition for determining how and when, respectively, the additional action is to be performed. For example, the created or selected action rule may even determine whether a notification is to be sent to the watcher or not, and whether a report, result or outcome of the additional action is to be included in the notification. In that case, it is possible to basically control the flow of notifications in the notification service by means of action rules. As indicated above, more than one trigger condition may be defined in the action rule.

The next FIG. 4 illustrates basically a continuation of the procedure in FIG. 3, as indicated by the dashed arrow, and represents the run-time phase of this procedure. In a first shown act 400, the notification server receives an event publication referring to the presentity, either from the presentity itself or from a network or other node that is configured to provide event publications related to the presentity, basically corresponding to act 2:4 above. As mentioned above, an event publication may be received as a notification from another notification server in the case where the presentity and watcher are served by different notification servers, e.g. including an RLS serving the watcher.

The notification server then checks or evaluates the event publication against the above-activated action rule, in a following act 402, basically corresponding to act 2:6 above, e.g. by first mapping the received event publication of the presentity to the activated action rule which was associated to that presentity in the above act 314. Next, it is determined whether the trigger condition in the action rule is fulfilled or not by the event publication and its circumstances, in a further shown act 404. This evaluation can be performed in a range of different ways, e.g. according to the examples of trigger conditions described above for act 2:3, and the invention is not limited in this respect.

If the notification server determines that the trigger condition is not fulfilled for the received event publication, no additional action is executed as indicated by an act 406, and the event publication is handled according to regular procedures, e.g. sending a notification to the watcher. On the other hand, if the trigger condition is found to be fulfilled, the additional action is executed, or at least initiated or triggered, by the notification server in a final shown act 408, basically corresponding to act 2:7 above, e.g. in addition to sending a regular notification to the watcher.

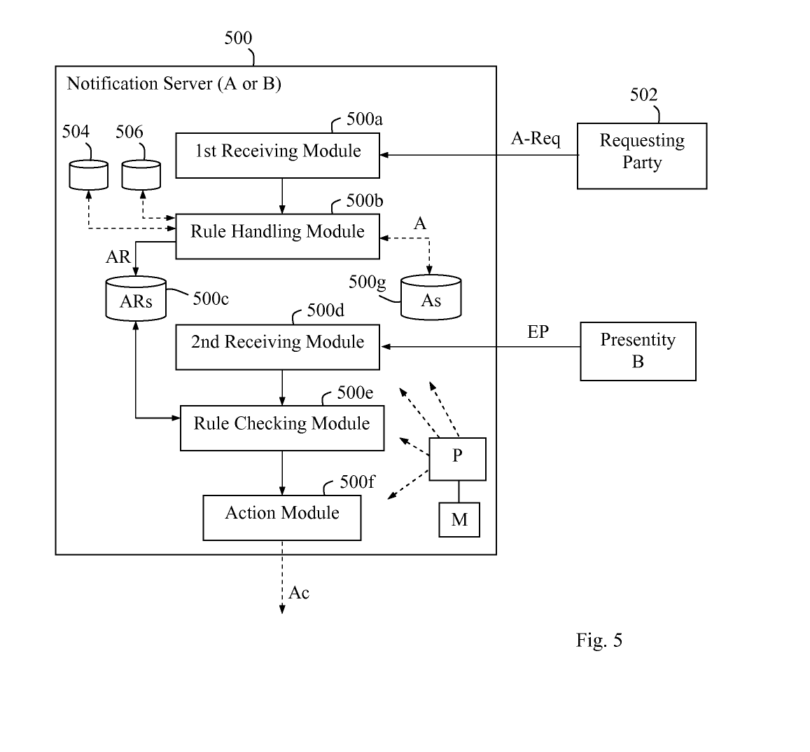

A more detailed but non-limiting example of how an arrangement can be implemented in a notification server to accomplish the above-described solution, is illustrated by the block diagram in FIG. 5. The notification server 500 is thus configured to provide notifications regarding a presentity to a subscribing watcher, e.g. in the manner described above for any of FIGS. 2-4.

According to this arrangement, the notification server 500 comprises a first receiving module 500a adapted to receive from a requesting party 502 a request “A-Req” for an additional action apart from said notifications and dependent on or triggered by event publications referring to the presentity. The notification server 500 further comprises a rule handling module 500b adapted to activate an action rule “AR” in an action rules repository 500c, the action rule comprising a trigger condition for performing the requested additional action. The activated action rule AR is also associated to the presentity B in order to map any incoming event publication thereto.

The notification server 500 also comprises a second receiving module 500d adapted to receive an event publication “EP” referring to the presentity B, and a rule checking module 500e adapted to check the event publication against the above-activated action rule to determine whether the trigger condition in the action rule is fulfilled or not by the event publication. The notification server 500 further comprises an action module 500f adapted to execute or at least initiate the additional action “Ac” if the trigger condition in the action rule is deemed to be fulfilled.

It should be noted that FIG. 5 merely illustrates various functional modules or units in the notification server 500 in a logical sense, although the skilled person is free to implement these functions in practice using suitable software and hardware means. Thus, this aspect of the solution is generally not limited to the shown structures of the notification server 500, while its functional modules 500a-500f may be configured to operate according to the features described for any of FIGS. 2-4 above, where appropriate.

The functional modules 500a-500f described above can be implemented in the notification server 500 as program modules of a computer program comprising code means which, when run by a processor “P” in the notification server 500, causes the server 500 to perform the above-described functions and actions. The processor P may be a single CPU (Central processing unit), or could comprise two or more processing units. For example, the processor P may include general purpose microprocessors, instruction set processors and/or related chips sets and/or special purpose microprocessors such as ASICs (Application Specific Integrated Circuit). The processor P may also comprise a storage for caching purposes.

The computer program may be carried by a computer program product in the notification server 500 in the form of a memory “M” connected to the processor P. The computer program product or memory M comprises a computer readable medium on which the computer program is stored. For example, the memory M may be a flash memory, a RAM (Random-access memory), a ROM (Read-Only Memory) or an EEPROM (Electrically Erasable Programmable ROM), and the program modules could in alternative embodiments be distributed on different computer program products in the form of memories within the notification server 500.

The above notification server 500 and functional modules 500a-500f may be configured or adapted to operate according to various optional embodiments. For example, the rule handling module 500b may be further adapted to activate the action rule by installing a new action rule in the action rules repository 500c or by selecting an already existing action (A) for activation in the action rules repository. The rule handling module 500b may select and fetch the already existing action A from a storage 500g with predefined actions As.

In another possible embodiment, the first receiving module 500a is further adapted to receive the request for an additional action in an XCAP message or in a SUBSCRIBE message. In another possible embodiment, the rule handling module 500b is further adapted to perform at least one of: authorising the requesting party based on preset access rules 504 and authenticating the requesting party based on preset authentication rules 506, as indicated by respective dashed arrows, before activating the action rule. The second receiving module 500d may also be further adapted to receive the event publication as a notification from another notification server wherein the presentity and watcher are served by different notification servers.

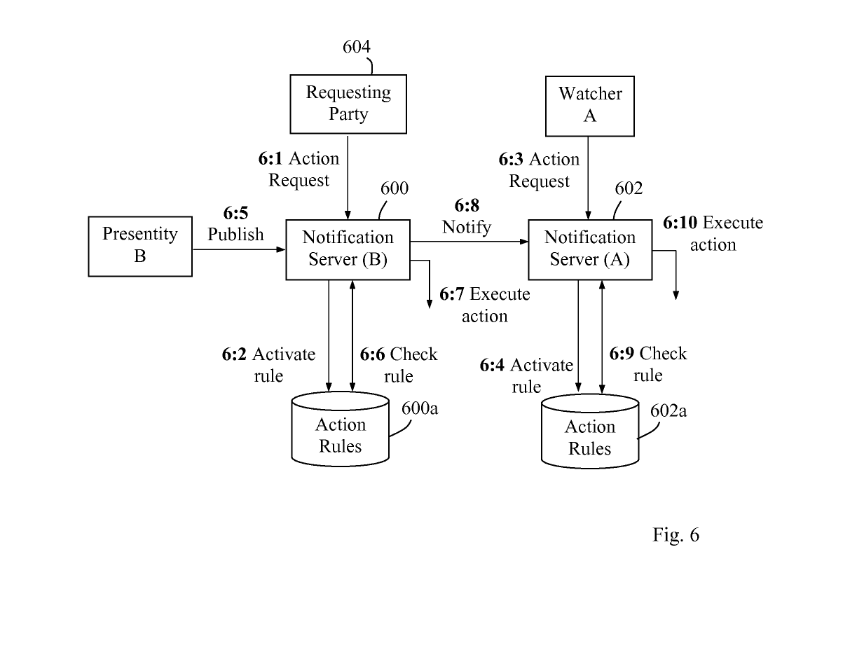

FIG. 6 illustrates another communication scenario where the watcher A and the presentity B are served by different notification servers 600 and 602 with respective action rules repositories 600a and 600b, in a notification service involving regular notifications as described above. Each notification server 600 and 602 may have its own collection of predefined actions, such as in storage 212 of FIG. 2. A possible example of how the present solution can be used for implementing additional actions in both servers 600 and 602 as triggered by event publications originating from the presentity B, will now be described. In a variant thereof, it is also possible to implement an additional action only in server 602 and not in server 600. Notification server 602 may be an RLS.

A first act 6:1 illustrates that the notification server 600 receives a request from a requesting party 604 for an additional action, apart from regular notifications, which is dependent on or triggered by event publications referring to the presentity B. The requesting party 604 may be the presentity B or a third party, etc. A next act 6:2 illustrates that the notification server 600 activates an action rule for the requested additional action in the action rules repository 600a, basically as described for act 2:3 above.

In this example however, the notification server 602 receives as well, in an act 6:3, a request from watcher A, thus being a requesting party, for another additional action apart from regular notifications, which is likewise dependent on or triggered by the event publications referring to the presentity. The request may alternatively be received from a third party. A next act 6:4 illustrates that the notification server 602 activates an action rule for the requested additional action in the action rules repository 602a, e.g. in the manner described above. Each action rule of acts 6.2 and 6:4 thus basically comprises a definition of how the additional action is to be executed and a trigger condition for when that action is to be executed, as described above. It should be noted that the two action rules above are independent of one another and may refer to different actions and/or trigger conditions.

A next act 6:5 illustrates that notification server 600 receives an event publication referring to presentity B, and the notification server 600 checks whether the trigger condition in the action rule in repository 600a is fulfilled by the event publication or not, in a further act 6:6. The action is then executed or at least initiated in a further act 6:7 if the trigger condition is fulfilled. In this example, a regular notification is also sent from notification server 600 to the other notification server 602, in a further act 6:8, which may then be forwarded or not in a notification to the notification server 602 of watcher A, not shown, acceding to the ongoing notification service. In this example, the notification received by notification server 602 in act 6:8 is effectively an event publication referring to presentity B. Consequently, notification server 602 basically performs the above-described procedure as well by checking the trigger condition in the action rule in repository 602a in a further act 6:9, and then executing or at least initiating the action in a further act 6:10 if the trigger condition is fulfilled.

The above-described procedure of implementing additional actions triggered by event publications originating from the presentity B can be modified in different ways. For example, a notification server may receive requests for additional actions from more than one requesting party, e.g. from both the watcher and the presentity. In that case, when receiving an event publication referring to the presentity, the notification server will check the action rule activated for the watcher and also check the action rule activated for the presentity. Actions will then be executed or initiated depending on whether the trigger conditions in the respective action rules are fulfilled by the event publication or not. These action rules may thus have different trigger conditions such that the corresponding actions will be executed or not independent from each other. The event publication may thus trigger an additional action in notification server 602 but not in notification server 600, and vice versa.

It is also possible that two notification servers, such as 600 and 602, may have a common action rules repository for handling their respective action rules, i.e. repositories 600a and 600b may be combined into a single action rules repository. The additional action(s) may also be generic and applied for any presentity and/or watcher. Further, the two notification servers 600 and 602 may also have their own storages for predefined actions or a common storage therefor.

While the invention has been described with reference to specific exemplary embodiments, the description is generally only intended to illustrate the inventive concept and should not be taken as limiting the scope of the invention. For example, the terms “notification server”, “presentity”, “watcher”, “requesting party”, “event publication”, “additional action” and “trigger condition” have been used throughout this description, although any other corresponding nodes, functions, and/or parameters could also be used having the features and characteristics described here. The invention is defined by the appended claims.

1-20. (canceled)

21. A method for controlling actions in a notification server that provides notifications regarding a presentity to a subscribing watcher, the method comprising:
receiving from a requesting party a request for an additional action apart from said notifications and dependent on event publications referring to the presentity,
activating an action rule in an action rules repository, the action rule comprising a trigger condition for performing the requested additional action,
receiving an event publication referring to the presentity,
checking the event publication against said action rule to determine whether said trigger condition in the action rule is fulfilled or not by the event publication, and
executing or initiating said additional action if the trigger condition in the action rule is fulfilled.

22. The method according to claim 21, wherein the requesting party is one of: the watcher, the presentity, a third party and an administrator associated with the watcher or the presentity.

23. The method according to claim 21, wherein the trigger condition refers to at least one of: type of event publication, time of day, week or season, and a value of a reported parameter in the event publication.

24. The method according to claim 21, wherein the additional action or the trigger condition refers to a specific presentity or watcher or generally to any presentity or watcher.

25. The method according to claim 21, wherein activating the action rule comprises creating and installing a new action rule in the action rules repository, or selecting an already existing action for activation in the action rules repository.

26. The method according to claim 21, wherein the request for an additional action is received in an XCAP message or in a SUBSCRIBE message.

27. The method according to claim 21, the method further comprising at least one of: authorising the requesting party based on preset access rules and authenticating the requesting party based on preset authentication rules, before activating said action rule.

28. The method according to claim 21, wherein the additional action involves at least one of: a logic for processing or handling information in the event publication, and sending an e-mail to the watcher or the presentity or to a third party.

29. The method according to claim 21, wherein said action rule determines at least one of whether a notification is to be sent to the watcher or not, and whether a report, result or outcome of the additional action is to be included in the notification.

30. The method according to claim 21, wherein said event publication is received as a notification from another notification server wherein the presentity and watcher are served by different notification servers.

31. An arrangement in a notification server configured to provide notifications regarding a presentity to a subscribing watcher, the arrangement comprising:
a first receiving module configured to receive from a requesting party a request for an additional action apart from said notifications and dependent on event publications referring to the presentity,
a rule handling module configured to activate an action rule in an action rules repository, the action rule comprising a trigger condition for performing the requested additional action,
a second receiving module configured to receive an event publication referring to the presentity,
a rule checking module configured to check the event publication against said action rule to determine whether said trigger condition in the action rule is fulfilled or not by the event publication, and
an action module configured to execute or initiate said additional action if the trigger condition in the action rule is fulfilled.

32. The arrangement according to claim 31, wherein the requesting party is one of: the watcher, the presentity, a third party and an administrator associated with the watcher or the presentity.

33. The arrangement according to claim 31, wherein the trigger condition refers to at least one of: type of event publication, time of day, week or season, and a value of a reported parameter in the event publication.

34. The arrangement according to claim 31, wherein the additional action or the trigger condition refers to a specific presentity or watcher or generally to any presentity or watcher.

35. The arrangement according to claim 31, wherein the rule handling module is further configured to activate the action rule by creating and installing a new action rule in the action rules repository, or by selecting an already existing action for activation in the action rules repository.

36. The arrangement according to claim 31, wherein the first receiving module is further configured to receive the request for an additional action in an XCAP message or in a SUBSCRIBE message.

37. The arrangement according to claim 31, wherein the rule handling module is further configured to perform at least one of: authorising the requesting party based on preset access rules and authenticating the requesting party based on preset authentication rules, before activating said action rule.

38. The arrangement according to claim 31, wherein the additional action involves at least one of: a logic for processing or handling information in the event publication, and sending an e-mail to the watcher or the presentity or to a third party.

39. The arrangement according to claim 31, wherein said action rule determines at least one of whether a notification is to be sent to the watcher or not, and whether a report, result or outcome of the additional action is to be included in the notification.

40. The arrangement according to claim 31, wherein the second receiving module is further configured to receive said event publication as a notification from another notification server wherein the presentity and watcher are served by different notification servers.
